(19) United States
(12) Patent Application Publication
(10) Pub. No.: US 2026/0025801 A1
(43) Pub. Date: Jan. 22, 2026

(54) A METHOD TO OPTIMIZE INITIAL ACCESS LATENCY

(71) Applicant: Nokia Technologies Oy, Espoo (FI)

(72) Inventors: Ethiraj ALWAR, Bangalore (IN); Subramanya CHANDRASHEKAR, Bangalore (IN)

(21) Appl. No.: 18/995,523

(22) PCT Filed: Jul. 25, 2022
(86) PCT No.: PCT/EP2022/070803

§ 371 Date: Jan. 16, 2025

(51) Int. Cl. H04W 72/0453; H04W 12/08; H04W 76/20

(52) U.S. Cl. CPC H04W 72/0453; H04W 12/08; H04W 76/20

(57) ABSTRACT

An apparatus comprising means for receiving an interface setup request from a distributed unit of a wireless communication network; means for preparing a first information element for informing non-user equipment specific and common radio bearer configuration for a signalling radio bearer between a central unit and the user equipment; means for preparing a second information element for informing non-user equipment specific frequency band information; means for preparing a third information element for informing a common non-user equipment specific security mode related information; means for including the first information element, the second information element and the third information element in a setup response message; and means for sending the setup response message to the distributed unit.

### TECHNICAL FIELD

The present invention relates to interactions between a distributed unit and a central unit of a wireless communication network during an initial access phase.

### BACKGROUND

5G specifications provide an option to split the internal structure of an access node gNodeB (gNB) into entities called CU (Central Unit) and one or more DUs (Distributed Unit), which are connected by a F1 interface, as specified in 3GPP 38.473. The split may provide traffic aggregation in terms of one gNB CU (or gNB-CU) serving a plurality of gNB DUs (or gNB-DU) operating as the actual node points for the air interface. There may also be a RAN (Radio Access Network) intelligent controller (RIC) connected through an E2 interface to the nodes gNB-DU and gNB-CU. RIC is a logical function that may be further divided into functions of a non-real-time RIC and a near-real-time RIC. The near-real-time RIC enables near-real-time control and optimization of RAN elements and resources via fine-grained data collection and actions over E2 interface.

The DU has fixed computing resources to be used, for example, for establishing calls, handling user plane (U-plane) data, scheduling etc. The DU's computing resources are further split among cells, and the real time resources within a cell are dedicated. The cells utilise their respective real time computing resources differently due to varying cell load and number of users. For addressing the dynamic variation of the real time computing resources between the cells, the DU may be provided with a baseband resource pooling functionality, which enables to share the computing resources between cells based on cell loads.

An initial access in 5G is primarily composed of RRC setup procedure which provides a dedicated connection to the UE to establish a session with the network. In the disaggregated architecture, both the CU and the DU are involved during the RRC setup phase. However, due to a functional split between CU and DU, an initial access call flow involves multiple exchanges over an F1 Application Protocol (F1AP) as shown in FIG. 4.

### SUMMARY

Now, an improved method and technical equipment implementing the method has been invented, by which the above problems are alleviated. Various aspects include a method, an apparatus and a non-transitory computer readable medium comprising a computer program, or a signal stored therein, which are characterized by what is stated in the independent claims. Various details of the embodiments are disclosed in the dependent claims and in the corresponding images and description.

The scope of protection sought for various embodiments of the invention is set out by the independent claims. The embodiments and features, if any, described in this specification that do not fall under the scope of the independent claims are to be interpreted as examples useful for understanding various embodiments of the invention.

According to an embodiment, interactions between the DU and CU during the initial access phase may be minimized by a Radio Bearer Configuration for a signalling radio bearer 1 (SRB1) as non-UE specific information element (IE), wherein the RadioBearerConfig for SRB1 does not contain any UE-specific information and hence it may be made common for all UEs and hence exchanged upfront in a non-UE associated message, e.g. as a part of the F1 Setup procedure. If need be, it can be updated using gNB-CU Configuration procedure later.

According to another embodiment, interactions between the DU and CU during the initial access phase may be minimized by simplified security during initial access: enabling a default security algorithm configuration thereby eliminating the dependency on Next Generation Application Protocol (NG Application Protocol, NGAP) signaling during initial access. This is postponed to a later phase. Security Algorithm selection is possible only after receiving the NGAP: Initial Context Setup Request from an access and mobility function (AMF)/core network (CN). Hence, a NULL security algorithm is proposed during the RRC setup phase.

According to another embodiment, interactions between the DU and CU during the initial access phase may be minimized by a common frequency band filter. This may be common for all UEs. This may also be sent from CU to DU during F1 setup procedure.

According to an embodiment, the following information elements (IE) may be exchanged between CU and DU:
Radio Bearer Config for SRB1;
Frequency Band Filter;
NULL AS Security Allowed.

According to a first aspect, there is provided an apparatus comprising means for receiving an interface setup request from a distributed unit of a wireless communication network; means for preparing a first information element for informing non-user equipment specific and common radio bearer configuration for a signalling radio bearer between a central unit and a user equipment; means for preparing a second information element for informing non-user equipment specific frequency band information; means for preparing a third information element for informing a common non-user equipment specific security mode related information; means for including the first information element, the second information element and the third information element in a setup response message; and means for sending the setup response message to the distributed unit.

An apparatus according to a second aspect comprises at least one processor and at least one memory, said at least one memory stored with computer program code thereon, the at least one memory and the computer program code configured to, with the at least one processor, cause the apparatus at least to: receive an interface setup request from a distributed unit of a wireless communication network; prepare a first information element for informing non-user equipment specific and common radio bearer configuration for a signalling radio bearer between a central unit and a user equipment; prepare a second information element for informing non-user equipment specific frequency band information; prepare a third information element for informing a common non-user equipment specific security mode related information; include the first information element, the second information element and the third information element in a setup response message; and send the setup response message to the distributed unit.

According to an embodiment, the apparatus is comprised in a central unit of an access node.

According to an embodiment, the control unit is comprised in a near-real-time radio access network intelligent controller.

According to an embodiment, the apparatus comprises computer program code configured to cause the apparatus to: indicate whether NULL security mode is allowed; and/or indicate a non-user equipment specific frequency band filter.

According to an embodiment, the apparatus comprises computer program code configured to cause the apparatus to: perform admission control after the connection setup has been completed.

According to an embodiment, the apparatus comprises computer program code configured to cause the apparatus to: receive an initial uplink radio resource control message indicating that the connection setup has been completed.

According to an embodiment, the apparatus comprises computer program code configured to cause the apparatus to: enable a default security algorithm configuration thereby eliminating a dependency on NG Application Protocol signaling during initial access.

According to an embodiment, the apparatus comprises computer program code configured to cause the apparatus to: include indication of a common frequency band filter in the setup response message.

According to an embodiment, the apparatus comprises computer program code configured to cause the apparatus to: include indication of access stratum security establishment preference.

A method according to a third aspect comprises receiving an interface setup request from a distributed unit of a wireless communication network; preparing a first information element for informing non-user equipment specific and common radio bearer configuration for a signalling radio bearer between a central unit and a user equipment; preparing a second information element for informing non-user equipment specific frequency band information; preparing a third information element for informing a common non-user equipment specific security mode related information; including the first information element, the second information element and the third information element in a setup response message; and sending the setup response message to the distributed unit.

According to a fourth aspect, there is provided an apparatus comprising means for receiving a radio resource control setup request from a user equipment; means for processing the radio resource control setup request using a non-user equipment specific information received earlier from a central unit; and means for completing the radio resource control connection setup procedure without needing to communicate with the central unit.

An apparatus according to a fifth aspect comprises at least one processor and at least one memory, said at least one memory stored with computer program code thereon, the at least one memory and the computer program code configured to, with the at least one processor, cause the apparatus at least to: receive a radio resource control setup request from a user equipment; process the radio resource control setup request using a non-user equipment specific information received earlier from a central unit; and complete the radio resource control connection setup procedure without needing to communicate with the central unit.

According to an embodiment, the apparatus is comprised in a distributed unit of an access node.

A method according to a sixth aspect comprises receiving a radio resource control setup request from a user equipment; processing the radio resource control setup request using a non-user equipment specific information received earlier from a central unit; and completing the radio resource control connection setup procedure without needing to communicate with the central unit.

Computer readable storage media according to further aspects comprise code for use by an apparatus, which when executed by a processor, causes the apparatus to perform the above methods.

### BRIEF DESCRIPTION OF THE DRAWINGS

For a more complete understanding of the example embodiments, reference is now made to the following descriptions taken in connection with the accompanying drawings in which:

FIG. 1 shows a schematic block diagram of an apparatus for incorporating functionalities for implementing various embodiments;

FIG. 2 shows schematically a layout of an apparatus according to an example embodiment;

FIG. 3 shows a part of an exemplifying radio access network;

FIG. 4 illustrates an initial access call flow according to an approach;

FIG. 5a shows an exemplified signalling chart for initial access signalling according to an embodiment;

FIG. 5b shows an exemplified signalling chart for initial access signalling according to another embodiment;

FIG. 6a shows signaling for initial access according to an embodiment; and

FIG. 6b shows signaling for initial access according to another embodiment; and

FIG. 7 shows a flow chart for a method for performing initial access according to an embodiment.

### DETAILED DESCRIPTION OF SOME EXAMPLE EMBODIMENTS

The following describes in further detail suitable apparatus and possible mechanisms carrying out the operations for sharing baseband computing resources from a pool of resources. While the following focuses on 5G networks, the embodiments as described further below are by no means limited to be implemented in said networks only, but they are applicable in any network and protocol entities supporting the split of the internal structure of an access node into a central unit and one or more distributed units.

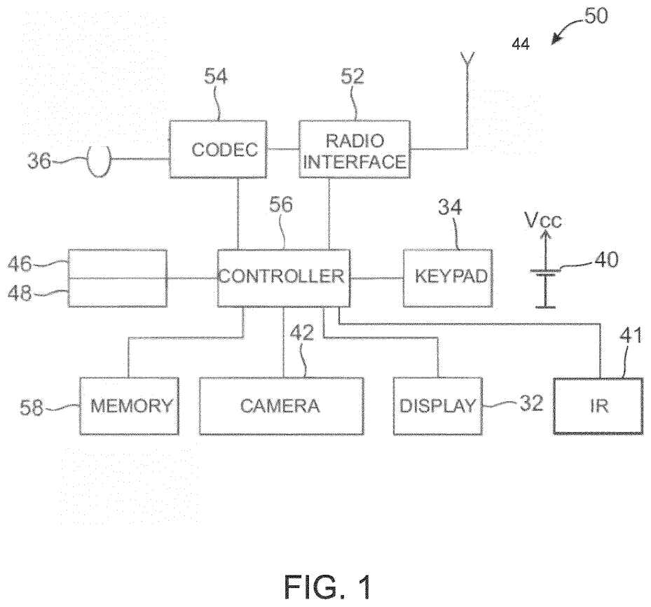

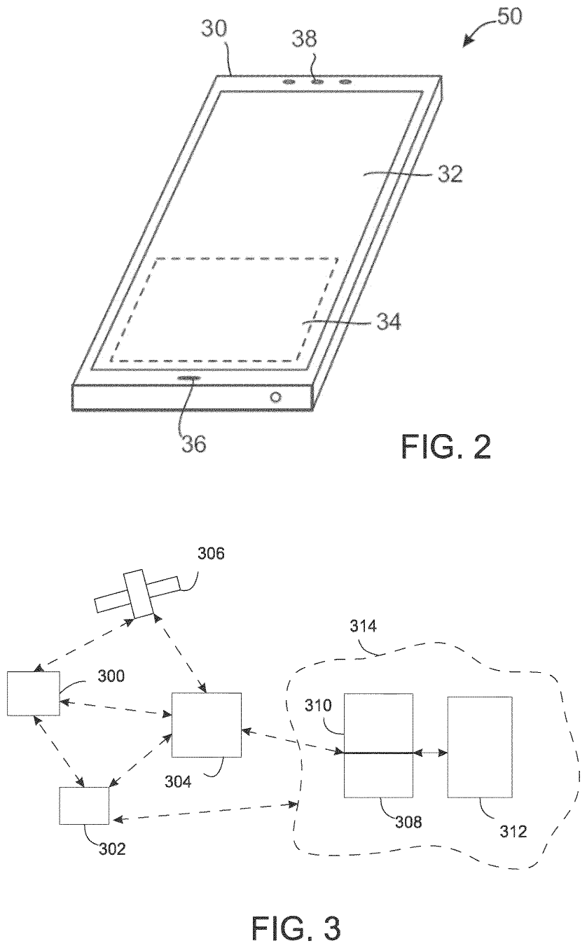

In this regard, reference is first made to FIGS. 1 and 2, where FIG. 1 shows a schematic block diagram of an exemplary apparatus or electronic device 50, which may incorporate the arrangement according to the embodiments. FIG. 2 shows a layout of an apparatus according to an example embodiment. The elements of FIGS. 1 and 2 will be explained next.

The electronic device 50 may for example be a user device, a mobile terminal or user equipment of a wireless communication system. The apparatus 50 may comprise a housing 30 for incorporating and protecting the device. The apparatus 50 further may comprise a display 32 and a keypad 34. Instead of the keypad, the user interface may be implemented as a virtual keyboard or data entry system as part of a touch-sensitive display.

The apparatus may comprise a microphone 36 or any suitable audio input which may be a digital or analogue signal input. The apparatus 50 may further comprise an audio output device, such as anyone of: an earpiece 38, speaker, or an analogue audio or digital audio output connection. The apparatus 50 may also comprise a battery 40 (or the device may be powered by any suitable mobile energy device such as solar cell, fuel cell or clockwork generator). The apparatus may further comprise a camera 42 capable of recording or capturing images and/or video. The apparatus 50 may further comprise an infrared port 41 for short range line of sight communication to other devices. In other embodiments the apparatus 50 may further comprise any suitable short-range communication solution such as for example a Bluetooth wireless connection or a USB/firewire wired connection.

The apparatus 50 may comprise a controller 56 or processor for controlling the apparatus 50. The controller 56 may be connected to memory 58 which may store both user data and instructions for implementation on the controller 56. The memory may be random access memory (RAM) and/or read only memory (ROM). The memory may store computer-readable, computer-executable software including instructions that, when executed, cause the controller/processor to perform various functions described herein. In some cases, the software may not be directly executable by the processor but may cause a computer (e.g., when compiled and executed) to perform functions described herein. The controller 56 may further be connected to codec circuitry 54 suitable for carrying out coding and decoding of audio and/or video data or assisting in coding and decoding carried out by the controller.

The apparatus 50 may comprise radio interface circuitry 52 connected to the controller and suitable for generating wireless communication signals for example for communication with a cellular communications network, a wireless communications system or a wireless local area network. The apparatus 50 may further comprise an antenna 44 connected to the radio interface circuitry 52 for transmitting radio frequency signals generated at the radio interface circuitry 52 to other apparatus(es) and for receiving radio frequency signals from other apparatus(es).

In the following, different exemplifying embodiments will be described using, as an example of an access architecture to which the embodiments may be applied, a radio access architecture based on Long Term Evolution Advanced (LTE Advanced, LTE-A) or new radio (NR, 5G), without restricting the embodiments to such an architecture, however. A person skilled in the art appreciates that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet protocol multimedia subsystems (IMS) or any combination thereof.

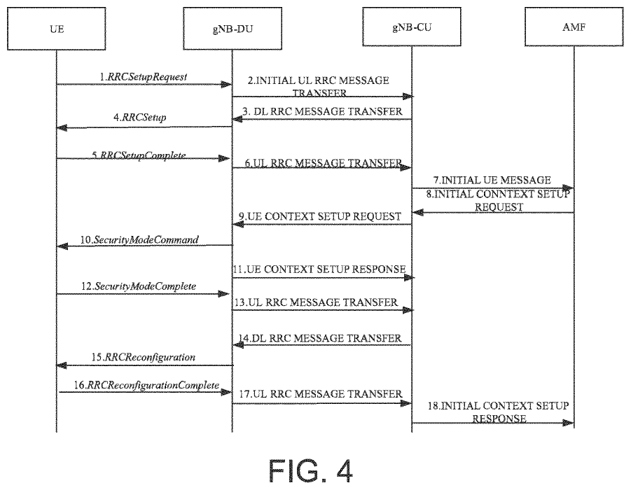

FIG. 3 depicts examples of simplified system architectures only showing some elements and functional entities, all being logical units, whose implementation may differ from what is shown. The connections shown in FIG. 3 are logical connections; the actual physical connections may be different. It is apparent to a person skilled in the art that the system typically comprises also other functions and structures than those shown in FIG. 3. The embodiments are not, however, restricted to the system given as an example but a person skilled in the art may apply the solution to other communication systems provided with necessary properties.

The example of FIG. 3 shows a part of an exemplifying radio access network.

FIG. 3 shows user devices 300 and 302 configured to be in a wireless connection on one or more communication channels in a cell with an access node (such as (e/g) NodeB or a base transceiver station (BTS)) 304 providing the cell. The physical link from a user device to a (e/g) NodeB is called uplink or reverse link and the physical link from the (e/g) NodeB to the user device is called downlink or forward link. It should be appreciated that (e/g) NodeBs or their functionalities may be implemented by using any node (such as Integrated Access and Backhaul (IAB) node), host, server or access point etc. entity suitable for such a usage.

A communication system typically comprises more than one (e/g) NodeB in which case the (e/g) NodeBs may also be configured to communicate with one another over links, wired or wireless, designed for the purpose. These links may be used for signaling purposes. The (e/g) NodeB is or comprises a computing device configured to control the radio resources of communication system it is coupled to. The NodeB may also be referred to as a base station, an access point, an access node or any other type of interfacing device including a relay station capable of operating in a wireless environment. The (e/g) NodeB includes or is coupled to transceivers. From the transceivers of the (e/g) NodeB, a connection is provided to an antenna unit that establishes bi-directional radio links to user devices. The antenna unit may comprise a plurality of antennas or antenna elements. The (e/g) NodeB is further connected to core network 310 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc. The CN may comprise network entities or nodes that may be referred to management entities. Examples of the network entities comprise at least an Access and Mobility Management Function (AMF).

In 5G NR, the User Plane Function (UPF) may be used to separate the control plane and the user plane functions. Therein, the Packet Gateway (PGW) control and user plane functions may be decoupled, whereby the data forwarding component (PGW-U) may be decentralized, while the PGW-related signaling (PGW-C) may remain in the core. This allows packet processing and traffic aggregation to be performed closer to the network edge, increasing bandwidth efficiencies while reducing network.

The user device (also called a user equipment (UE), a user terminal, a terminal device, a wireless device, a mobile station (MS) etc.) illustrates one type of an apparatus to which resources on the air interface are allocated and assigned, and thus any feature described herein with a user device may be implemented with a corresponding network apparatus, such as a relay node, an eNB, and an gNB. An example of such a relay node is a layer 3 relay (self-backhauling relay) towards the base station.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction. Accordingly, the user device may be an IoT-device. The user device may also utilize cloud. In some applications, a user device may comprise a small portable device with radio parts (such as a watch, earphones or eyeglasses) and the computation is carried out in the cloud. The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. The access nodes of the radio network form transmission/reception (TX/Rx) points (TRPs), and the UEs are expected to access networks of at least partly overlapping multi-TRPs, such as macro-cells, small cells, pico-cells, femto-cells, remote radio heads, relay nodes, etc. The access nodes may be provided with Massive MIMO antennas, i.e. very large antenna array consisting of e.g. hundreds of antenna elements, implemented in a single antenna panel or in a plurality of antenna panels, capable of using a plurality of simultaneous radio beams for communication with the UE. The UEs may be provided with MIMO antennas having an antenna array consisting of e.g. dozens of antenna elements, implemented in a single antenna panel or in a plurality of antenna panels. Thus, the UE may access one TRP using one beam, one TRP using a plurality of beams, a plurality of TRPs using one (common) beam or a plurality of TRPs using a plurality of beams.

The 4G/LTE networks support some multi-TRP schemes, but in 5G NR the multi-TRP features are enhanced e.g. via transmission of multiple control signals via multi-TRPs, which enables to improve link diversity gain. Moreover, high carrier frequencies (e.g., mmWaves) together with the Massive MIMO antennas require new beam management procedures for multi-TRP technology.

5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 6 GHz, cmWave and mmWave, and also capable of being integrated with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT (Radio Access Technology) operability (such as LTE-5G) and inter-RI operability (inter-radio interface operability, such as below 6 GHZ-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

Frequency bands for 5G NR are separated into two frequency ranges: Frequency Range 1 (FR1) including sub-6 GHz frequency bands, i.e. bands traditionally used by previous standards, but also new bands extended to cover potential new spectrum offerings from 410 MHz to 7125 MHz, and Frequency Range 2 (FR2) including frequency bands from 24.25 GHz to 52.6 GHz. Thus, FR2 includes the bands in the mmWave range, which due to their shorter range and higher available bandwidth require somewhat different approach in radio resource management compared to bands in the FR1.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 312, or utilize services provided by them. The communication network may also be able to support the usage of cloud services, for example at least part of core network operations may be carried out as a cloud service (this is depicted in FIG. 3 by “cloud” 314). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head, radio unit (RU) or base station comprising radio parts. It is also possible that node operations will be distributed among a plurality of servers, nodes or hosts. Application of cloudRAN architecture enables RAN real time functions being carried out at the RAN side (e.g. in a distributed unit, DU) and non-real time functions being carried out in a centralized manner (e.g. in a centralized unit, CU 308).

While Cloud RAN and Open RAN (ORAN or O-RAN) may have ties and may often be discussed together, they may also be considered as different technologies and one can be applied without the other. Open RAN for example defines open interfaces between network elements, while Cloud RAN for example may virtualize the baseband and separate baseband hardware and software. The open radio access network, O-RAN, as defined by the Open RAN Alliance, refers to a concept enabling interoperability of RAN elements between different vendors over a set of defined interfaces. Thus, O-RAN architecture for example enables baseband unit and radio unit components from different vendors to operate together.

It should also be understood that the distribution of labor between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (e/gNB). It should be appreciated that MEC can be applied in 4G networks as well. The gNB is a next generation Node B (or, new Node B) supporting the 5G network (i.e., the NR).

5G may also utilize non-terrestrial nodes 306, e.g. access nodes, to enhance or complement the coverage of 5G service, for example by providing backhauling, wireless access to wireless devices, service continuity for machine-to-machine (M2M) communication, service continuity for Internet of Things (IoT) devices, service continuity for passengers on board of vehicles, ensuring service availability for critical communications and/or ensuring service availability for future railway/maritime/aeronautical communications. The non-terrestrial nodes may have fixed positions with respect to the Earth surface or the non-terrestrial nodes may be mobile non-terrestrial nodes that may move with respect to the Earth surface. The non-terrestrial nodes may comprise satellites and/or HAPSs (High Altitude Platform Stations). Satellite communication may utilize geostationary earth orbit (GEO) satellite systems, but also low earth orbit (LEO) satellite systems, in particular mega-constellations (systems in which hundreds of (nano) satellites are deployed). Each satellite in the mega-constellation may cover several satellite-enabled network entities that create on-ground cells. The on-ground cells may be created through an on-ground relay node 304 or by a gNB located on-ground or in a satellite.

A person skilled in the art appreciates that the depicted system is only an example of a part of a radio access system and in practice, the system may comprise a plurality of (e/g) NodeBs, the user device may have an access to a plurality of radio cells and the system may comprise also other apparatuses, such as physical layer relay nodes or other network elements, etc. At least one of the (e/g) NodeBs or may be a Home (e/g) nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g) NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g) NodeBs are required to provide such a network structure.

For fulfilling the need for improving the deployment and performance of communication systems, the concept of “plug-and-play” (e/g) NodeBs has been introduced. Typically, a network which is able to use “plug-and-play” (e/g) Node Bs, includes, in addition to Home (e/g) NodeBs (H (e/g) nodeBs), a home node B gateway, or HNB-GW (not shown in FIG. 1). A HNB Gateway (HNB-GW), which is typically installed within an operator's network may aggregate traffic from a large number of HNBs back to a core network.

The Radio Resource Control (RRC) protocol is used in various wireless communication systems for defining the air interface between the UE and a base station, such as eNB/gNB. This protocol is specified by 3GPP in in TS 36.331 for LTE and in TS 38.331 for 5G. In terms of the RRC, the UE may operate in LTE and in 5G in an idle mode or in a connected mode, wherein the radio resources available for the UE are dependent on the mode where the UE at present resides. In 5G, the UE may also operate in inactive mode. In the RRC idle mode, the UE has no connection for communication, but the UE is able to listen to page messages. In the RRC connected mode, the UE may operate in different states, such as CELL_DCH (Dedicated Channel), CELL_FACH (Forward Access Channel), CELL_PCH (Cell Paging Channel) and URA_PCH (URA Paging Channel). The UE may communicate with the eNB/gNB via various logical channels like Broadcast Control Channel (BCCH), Paging Control Channel (PCCH), Common Control Channel (CCCH), Dedicated Control Channel (DCCH), Dedicated Traffic Channel (DTCH).

The transitions between the states are controlled by a state machine of the RRC. When the UE is powered up, it is in a disconnected mode/idle mode. The UE may transit to RRC connected mode with an initial attach or with a connection establishment. If there is no activity from the UE for a short time, eNB/gNB may suspend its session by moving to RRC Inactive and can resume its session by moving to RRC connected mode. The UE can move to the RRC idle mode from the RRC connected mode or from the RRC inactive mode.

The actual user and control data from network to the UEs is transmitted via downlink physical channels, which in 5G include Physical downlink control channel (PDCCH) which carries the necessary downlink control information (DCI), Physical Downlink Shared Channel (PDSCH), which carries the user data and system information for user, and Physical broadcast channel (PBCH), which carries the necessary system information to enable a UE to access the 5G network.

The user and control data from UE to the network is transmitted via uplink physical channels, which in 5G include Physical Uplink Control Channel (PUCCH), which is used for uplink control information including HARQ (Hybrid Automatic Repeat reQuest) feedback acknowledgments, scheduling request, and downlink channel-state information for link adaptation, Physical Uplink Shared Channel (PUSCH), which is used for uplink data transmission, and Physical Random Access Channel (PRACH), which is used by the UE to request connection setup referred to as random access.

5G specifications provide an option to split the internal structure of a gNB into entities called CU (Central Unit) and one or more DUs (Distributed Unit), which are connected by a F1 interface, as specified in 3GPP 38.473. The split may provide traffic aggregation in terms of one gNB CU serving a plurality of gNB DUs operating as the actual node points for the air interface. The gNB-CU may be further split to CU-CP (Control Plane) and CU-UP (User Plane) and E1 interface has been introduced between them. Information of available resources and load must be shared across these network entities to implement various RRM (Radio Resource Management) functionalities.

F1 Application Protocol (F1AP) provides means to exchange control plane messages associated with the UE over an F1-C interface. F1AP provides the signalling service between a gNB-CU and a gNB-DU of a gNB within an NG-RAN, or between a gNB-CU and a gNB-DU of an en-gNB within an E-UTRAN. The services provided by the F1AP are divided into UE-associated and non-UE-associated. The UE-associated services are related to one UE and the non-UE-associated services are related to the F1 interface.

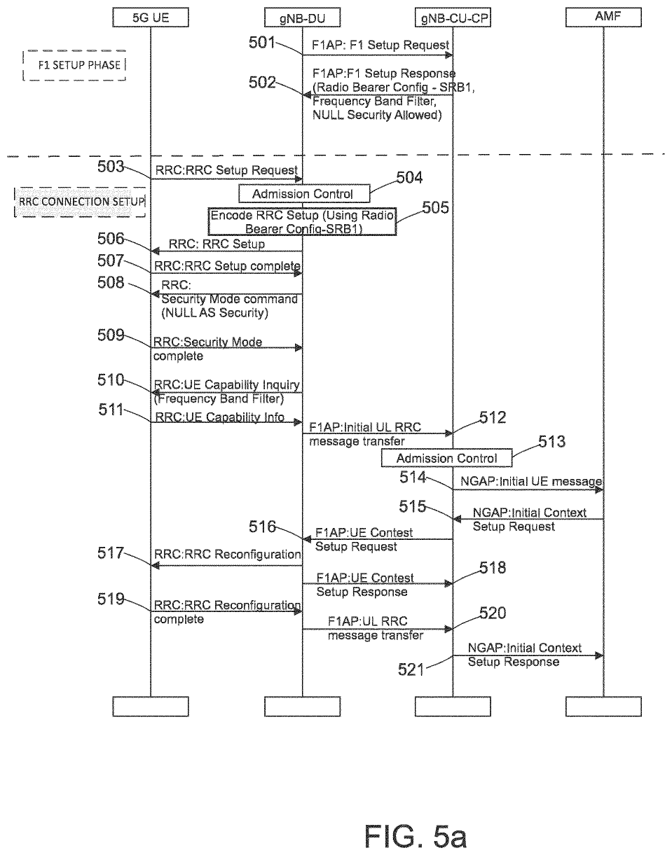

FIG. 4 illustrates an initial access call flow over F1AP. First, The UE sends an RRCSetupRequest message to the gNB-DU. The gNB-DU includes the RRC message and, if the UE is admitted, the corresponding low layer configuration for the UE in the INITIAL UL RRC MESSAGE TRANSFER message 2 and transfers to the gNB-CU. The gNB-CU allocates a gNB-CU UE F1AP ID for the UE and generates a RRCSetup message 3. towards UE. The gNB-DU sends the RRCSetup message 4 to the UE. The UE sends the RRC SETUP COMPLETE message 5 to the gNB-DU. The gNB-DU encapsulates the RRC message in the UL RRC MESSAGE TRANSFER message 6 and sends it to the gNB-CU. The gNB-CU sends the INITIAL UE MESSAGE message 7 to the AMF. The AMF sends the INITIAL CONTEXT SETUP REQUEST message 8 to the gNB-CU. The gNB-CU sends the UE CONTEXT SETUP REQUEST message 9 to establish the UE context in the gNB-DU. In this message, it may also encapsulate the SecurityModeCommand message. In case of NG-RAN sharing, the gNB-CU includes the serving PLMN ID (for SNPNs the serving SNPN ID). The gNB-DU sends the SecurityModeCommand message 10 to the UE. The gNB-DU sends the UE CONTEXT SETUP RESPONSE message 11 to the gNB-CU. The UE responds with the SecurityModeComplete message 12. The gNB-DU encapsulates the RRC message in the UL RRC MESSAGE TRANSFER message 13 and sends it to the gNB-CU. The gNB-CU generates the RRCReconfiguration message and encapsulates it in the DL RRC MESSAGE TRANSFER message 14. The gNB-DU sends RRCReconfiguration message 15 to the UE. The UE sends RRCReconfigurationComplete message 16 to the gNB-DU. The gNB-DU encapsulates the RRC message in the UL RRC MESSAGE TRANSFER message 17 and send it to the gNB-CU. The gNB-CU sends the INITIAL CONTEXT SETUP RESPONSE message 18 to the AMF.

As shown in FIG. 4, there are 8 messages exchanged over F1AP (messages numbered 2, 3. 6, 9, 11, 13, 14 and 17). With a one-way delay of 4 ms per message and with 8 messages to be exchanged in the call flow, F1AP messaging itself introduces a ballpark latency of 40 ms. This is very slow compared to LTE.

Radio Bearer Config contains SRB1 related info which is signalled over the F1AP for each initial access attempt. Also a frequency band filter for the UE Capability Enquiry is signalled over F1AP for each initial access attempt, and an AS Security Algorithm selection is done in the gNB-CU before triggering the RRC: Security Mode Command. Hence, this is possible only after receiving the NGAP: Initial Context Setup Request which contains the security algorithms supported by the UE.

Dual Connectivity (DC) is a feature supported in LTE and in 5G NR enabling aggregation of two radio links at the PDCP (Packet Data Convergence Protocol) layer level. For resource aggregation, a UE in RRC_CONNECTED state is allocated two radio links from two different network nodes that may be connected via a non-ideal backhaul. The first node, Master Node (MN), serves as mobility and signaling anchor and the second node, Secondary Node (SN), provides additional local radio resources for UE. The two resource sets are called as Master Cell Group (MCG, associated with MN) and Secondary Cell Group (SCG, associated with SN). The MN can be either LTE eNB or NR gNB. The SN can be either LTE eNB or NR gNB. The MN and the SN can be the same node.

Dual Connectivity can improve user throughput and mobility robustness, since the users may be connected simultaneously to MCG and SCG, as well as improve load balancing between MCG and SCG resources.

In the following, some embodiments will be described which aim to speed up the initial access procedure described above. The purpose is to ensure that the gNB-DU can complete the RRC setup procedure with the UE without involvement of gNB-CU during the initial access. According to an embodiment, the common and UE-dedicated aspects are separated during RRC setup and the UE-dedicated aspects are deferred to a later stage.

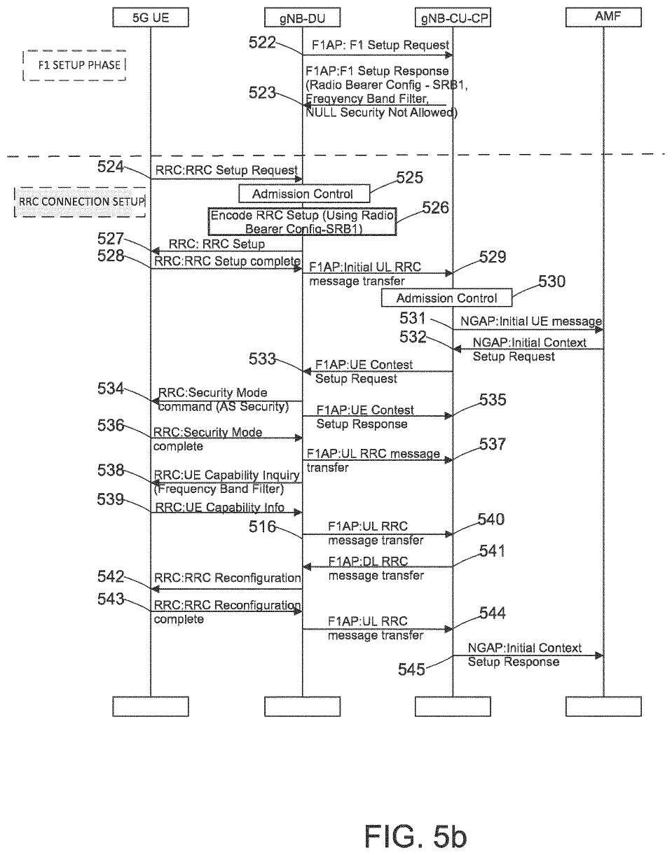

In accordance with an embodiment, the following procedure may be performed between the gNB-CU, the gNB-DU, the UE and the AMF, with reference to FIG. 5a.

At an F1 setup phase the gNB-DU sends an F1 Setup Request 501 to the gNB-CU, which replies with an F1 Setup Response message 502. The F1 Setup Response message comprises Radio Bearer Configuration for SRB1 between the gNB-CU and the gNB-DU as non-UE specific IE, information of a frequency band filter and indication of an AS (Access Stratum) Security Establishment preference (NULL security allowed).

After the F1 setup phase has been completed, RRC connection setup may be performed. The RRC Setup may comprise Cell Group Configuration and Radio Bearer Configuration (SRB1). The Cell Group Configuration information element (IE) is encoded by the gNB-DU. Radio Bearer Config for SRB1 is encoded in the gNB-CU and is included in the RRC Setup. The RadioBearerConfig for SRB1 may be made common for all UEs and exchanged upfront in a non-UE associated message, e.g. as a part of the F1 Setup procedure. In case of any configuration changes for Radio Bearer Config-SRB1, the gNB-CU may encode it and send it to the gNB-DU using gNB-CU Configuration procedure for a subsequent usage.

The exchange of radio bearer configuration for SRB1 between gNB-CU and gNB-DU as non-UE specific IE may be performed as follows.

The UE sends an RRC Setup Request message 503 to the gNB-DU.

The gNB-DU performs admission control 504 and encodes RRC Setup 505 using the Radio Bearer Configuration for SRB1. Then the gNB-DU sends an RRC Setup message 506 to the UE. After completing a setup procedure, the UE responds by sending an RRC Setup Complete message 507 to the gNB-DU.

Simplified Security during initial access may be performed so that a default security algorithm configuration (e.g. NULL security) is enabled to eliminate the dependency on NGAP signaling during the initial access. Hence, the real security procedure may be postponed to a later phase when the initial UE message is sent. A security algorithm selection is possible only after receiving the NGAP: Initial Context Setup Request from AMF/CN. The security algorithm is not necessary for SRB1 communication, hence, a NULL security algorithm may be used during the RRC setup phase.

A Security Mode Command establishes the AS Security for SRB1 using a security algorithm that matches to UE supported algorithms information of which may have been received from 5G Core in the NGAP: Initial Context Setup Request, and supported algorithms in gNB. To setup the security mode, the gNB-DU sends a Security Mode Command message 508 in this the security indication is as Null i.e. no security, wherein the UE responds by a Security Mode Complete message 509 to the gNB-DU. With such NULL algorithm, it may be possible for the gNB-DU to encode Security Mode Command and decode Security Mode Complete thereby eliminating the need for additional F1AP Messages.

Frequency Band Filter to be used in UE Capability Enquiry is dependent on the CU Configuration, but may be common for all UEs, wherein it is not needed to include any UE-specific aspects.

The gNB-DU may thus request from the UE capability information by sending an UE Capability Enquiry message 510, in which the frequency band filter may be indicated i.e. the enquiry message is related to find out properties supported by a frequency band filter of the UE. The UE responds by sending a UE Capability Information message 511 to the gNB-DU comprising information related to the requested property/properties.

Then, the gNB-DU sends an Initial UL RRC Message Transfer message 512 via the F1AP to the gNB-CU. The gNB-CU then performs its own admission control 513 and sends an Initial UE Message 514 to the AMF using the NG Application Protocol (NGAP).

The AMF sends an Initial Context Setup Request message 515 to the gNB-CU, which forwards 516 the message to the gNB-DU using the F1AP.

The gNB-DU sends an RRC Reconfiguration message 517 to the UE which begins the reconfiguration procedure.

The gNB-DU responds to the gNB-CU by sending a UE Context Setup Response message 518.

When the UE has completed the reconfiguration procedure, it sends an RRC Reconfiguration Complete message 519 to the gNB-DU.

The gNB-DU may then perform an UL RRC Message Transfer procedure 520 to transfer the initial RRC message to the gNB-CU using the F1AP.

The gNB-CU sends an Initial Context Setup Response message 521 to the AMF to inform that the context setup has been completed.

In accordance with another embodiment, the following procedure may be performed between the gNB-CU, the gNB-DU, the UE and the AMF, with reference to FIG. 5b. In this example the NULL security is not allowed.

At an F1 setup phase the gNB-DU sends an F1 Setup Request 522 to the gNB-CU, which replies with an F1 Setup Response message 523. The F1 Setup Response message comprises Radio Bearer Configuration for SRB1 between the gNB-CU and the gNB-DU as non-UE specific IE, information of a frequency band filter and indication of the AS Security Establishment preference (NULL security not allowed).

After the F1 setup phase has been completed, RRC connection setup may be performed. The RRC Setup may comprise Cell Group Configuration and Radio Bearer Configuration (SRB1). The Cell Group Configuration information element (IE) is encoded by the gNB-DU. Radio Bearer Config for SRB1 is encoded in the gNB-CU and is included in the RRC Setup. The RadioBearerConfig for SRB1 may be made common for all UEs and exchanged upfront in a non-UE associated message, e.g. as a part of the F1 Setup procedure. In case of any configuration changes for Radio Bearer Config-SRB1, the gNB-CU may encode it and send it to the gNB-DU using gNB-CU Configuration procedure for a subsequent usage.

The exchange of radio bearer configuration for SRB1 between gNB-CU and gNB-DU as non-UE specific IE may be performed as follows.

The UE sends an RRC Setup Request message 524 to the gNB-DU.

The gNB-DU performs admission control 525 and encodes RRC Setup 526 using the Radio Bearer Configuration for SRB1. Then the gNB-DU sends an RRC Setup message 527 to the UE. After completing a setup procedure, the UE responds by sending an RRC Setup Complete message 528 to the gNB-DU.

Then, the gNB-DU sends an Initial UL RRC Message Transfer message 529 via the F1AP to the gNB-CU. The gNB-CU then performs its own admission control 530 and sends an Initial UE Message 531 to the AMF using the NG Application Protocol (NGAP).

The AMF sends an Initial Context Setup Request message 532 to the gNB-CU, which forwards 533 the message to the gNB-DU using the F1AP.

A Security Mode Command establishes the AS Security for SRB1 using a security algorithm that matches to UE supported algorithms information of which may have been received from 5G Core in the NGAP: Initial Context Setup Request, and supported algorithms in gNB. To setup the security mode, the gNB-DU sends a Security Mode Command message 534 in this the security indication is AS Security.

The gNB-DU responds to the UE context setup request by sending a Context Setup Response message 535 to the gNB-CU.

The UE responds to the security mode command by sending a Security Mode Complete message 536 to the gNB-DU.

The gNB-DU may then perform an UL RRC Message Transfer procedure 537 to transfer the initial RRC message to the gNB-CU using the F1AP.

Frequency Band Filter to be used in UE Capability Enquiry is dependent on the CU Configuration, but may be common for all UEs, wherein it is not needed to include any UE-specific aspects.

The gNB-DU may thus request from the UE capability information by sending an UE Capability Enquiry message 538, in which the frequency band filter may be indicated i.e. the enquiry message is related to find out properties supported by a frequency band filter of the UE. The UE responds by sending a UE Capability Information message 539 to the gNB-DU comprising information related to the requested property/properties.

The gNB-DU may again perform an UL RRC Message Transfer procedure 540 to transfer the initial RRC message to the gNB-CU using the F1AP, and the gNB-CU may respond with a DL RRC Message Transfer procedure 541 to transfer an RRC message to the gNB-DU using the F1AP.

The gNB-DU sends an RRC Reconfiguration message 542 to the UE which begins the reconfiguration procedure.

When the UE has completed the reconfiguration procedure, it sends an RRC Reconfiguration Complete message 543 to the gNB-DU.

The gNB-DU may then perform the UL RRC Message Transfer procedure 544 to transfer the RRC Reconfiguration Complete message to the gNB-CU using the F1AP.

The gNB-CU sends an Initial Context Setup Response message 545 to the AMF to inform that the context setup has been completed.

Delayed gNB-Level Admission Control at CU

It is in generally expected that the CU dimensioning should typically not result in admission control failures at the gNB-CU. Hence, gNB-level admission control at the gNB-CU may be delayed until the RRC Connection Setup is complete. As was shown above, the initial access between the UE and gNB-DU can be performed without any gNB-Level Admission Control at the gNB-CU. If there is admission control failure, the gNB-CU will release the RRC Connection.

A concept of dual RRC may be utilized to encode and decode RRC messages involved in the Initial Access call flow. This may eliminate the need for CU-DU signaling during initial access.

In the following table details of some of the information elements are described:

| Sl. | | | |
|---|---|---|---|
| No | IE Name | TYPE | Description |
| 1 | RadioBearerConfig-SRB1 | OCTET | Radio Bearer Config for |
| | | STRING | SRB1 |
| 2 | frequencyBandListFilter | OCTET | Frequency Band List Filter |
| | | STRING | for NR |
| 3 | NULL Security Allowed | Boolean | Indicates whether DU can |
| | | | configure AS Security with |
| | | | NULL Security Algorithm |

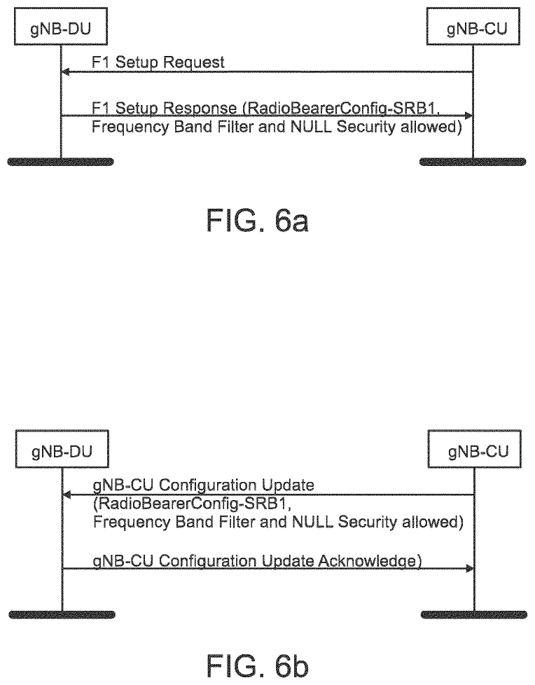

With the above embodiments, two options of the signaling for Initial Access Signalling are shown in FIGS. 6a and 6b. In the first option, AS Security for SRB1 is configured with NULL Algorithm i.e. security not allowed. After the receipt of NGAP: Initial Context Setup Request, AS Security is reconfigured. In the second option, an initial UL RRC Message transfer after the RRC Setup Complete is performed. The gNB-CU Configuration Update procedure includes the new values of the information elements RadioBearerConfig-SRB1, Frequency Band Filter, and NULL Security Allowed.

As shown in the signalling flows of FIGS. 6a and 6b, the signaling over F1AP is reduced to two messages. Accordingly, the overall latency may also reduce to 10 ms (2 messages) with this procedure compared to 40 ms (8 messages) in the current art.

According to an embodiment, the apparatus is comprised in a distributed unit of an access node and the control unit is comprised in a radio access network controller.

Thus, the distributed unit may be a gNB-DU and the control unit may be an RNC, for example.

According to an embodiment, the apparatus is comprised in a central unit of an access node.

Thus, the distributed unit may be a gNB-DU and the control unit may be an RIC, for example. As mentioned above, the RIC may be divided into functionalities of a non-real-time RIC and a near-real-time (near RT) RIC. In the following, some embodiments are described using the near RT RIC as an illustrative example. It is, nevertheless, noted that the embodiments described n the context of near RT RIC are equally applicable in non-real-time RIC, unless specifically being limited to near RT RIC.

The method and the embodiments related thereto may also be implemented in an apparatus implementing an access point or a base station of a radio access network, such as an eNB or a gNB. An apparatus, such as a gNB, according to an aspect comprises means for receiving by the apparatus a setup request from a distributed unit of a wireless communication network; means for preparing a first information element for informing non-user equipment specific radio bearer configuration for a signalling radio bearer between the central unit and the apparatus; means for preparing a second information element for informing non-user equipment specific frequency band information; means for preparing a third information element for informing security mode related information; means for including the first information element, the second information element and the third information element in a setup response message; and means for sending the setup response message to the distributed unit.

According to an embodiment, the means for preparing the third information element comprises means for indicating whether NULL security mode is allowed.

According to an embodiment, the means for preparing the second information element comprises means for indicating a non-user equipment specific frequency band filter.

According to an embodiment, the apparatus comprises means for performing admission control after the connection setup has been completed.

According to an embodiment, the apparatus comprises means for receiving an initial uplink radio resource control message indicating that the connection setup has been completed.

According to an embodiment, the apparatus comprises means for enabling a default security algorithm configuration thereby eliminating a dependency on NG Application Protocol signaling during initial access.

According to an embodiment, the apparatus comprises means for including indication of a common frequency band filter in the setup response message.

An apparatus, such as an access point or a base station of a radio access network, e.g. an eNB or a gNB, according to a further aspect comprises at least one processor and at least one memory, said at least one memory stored with computer program code thereon, the at least one memory and the computer program code configured to, with the at least one processor, cause the apparatus at least to perform: receive apparatus a setup request from a distributed unit of a wireless communication network; prepare a first information element for informing non-user equipment specific radio bearer configuration for a signalling radio bearer between the central unit and the apparatus; prepare a second information element for informing non-user equipment specific frequency band information; prepare a third information element for informing security mode related information; include the first information element, the second information element and the third information element in a setup response message; and send the setup response message to the distributed unit.

Such apparatuses may comprise e.g. the functional units disclosed in any of the FIGS. 1-3 for implementing the embodiments.

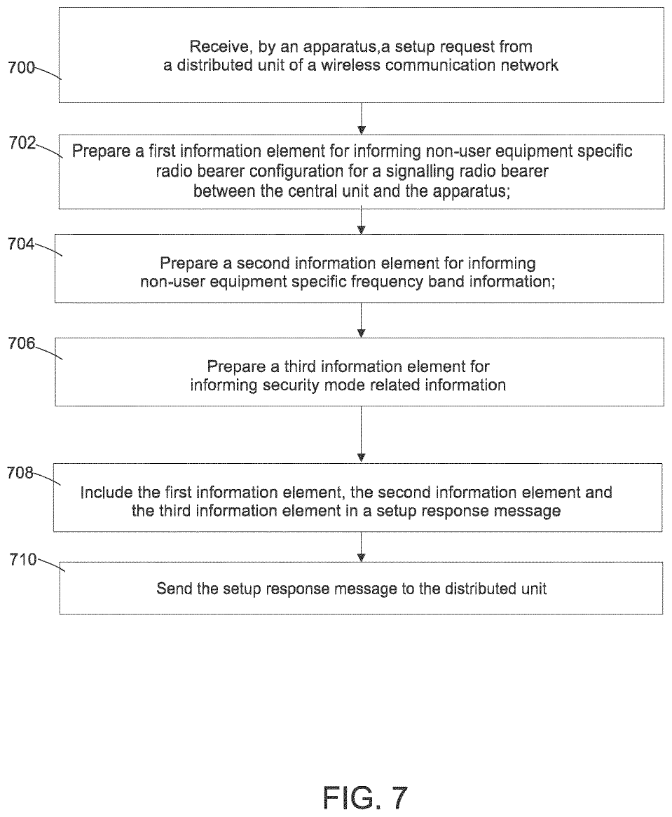

A method according to an embodiment is illustrated in the flow diagram of FIG. 7. A setup request is received 700 from a distributed unit of a wireless communication network. A first information element is prepared 702 for informing non-user equipment specific radio bearer configuration for a signalling radio bearer between the central unit and the apparatus. A second information element is prepared 704 for informing non-user equipment specific frequency band information. Also a third information element is prepared 706 for informing security mode related information. The first information element, the second information element and the third information element are included in 708 a setup response message. The setup response message is sent 710 to the distributed unit.

A further aspect relates to a computer program product, stored on a non-transitory memory medium, comprising computer program code, which when executed by at least one processor, causes an apparatus at least to perform: receive a setup request from a distributed unit of a wireless communication network; prepare a first information element for informing non-user equipment specific radio bearer configuration for a signalling radio bearer between the central unit and the apparatus; prepare a second information element for informing non-user equipment specific frequency band information; prepare a third information element for informing security mode related information; include the first information element, the second information element and the third information element in a setup response message; and send the setup response message to the distributed unit.

In general, the various embodiments of the invention may be implemented in hardware or special purpose circuits or any combination thereof. While various aspects of the invention may be illustrated and described as block diagrams or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended examples. However, all such and similar modifications of the teachings of this invention will still fall within the scope of this invention.

1.-19. (canceled)

20. An apparatus comprising:
at least one processor; and
at least one memory, said at least one memory stored with computer program code thereon, the at least one memory and the computer program code configured to, with the at least one processor, cause the apparatus at least to:
receive an interface setup request from a distributed unit of a wireless communication network:
prepare a first information element for informing non-user equipment specific and common radio bearer configuration for a signalling radio bearer between a central unit and a user equipment:
prepare a second information element for informing non-user equipment specific frequency band information:
prepare a third information element for informing a common non-user equipment specific security mode related information:
include the first information element, the second information element and the third information element in a setup response message; and
send the setup response message to the distributed unit.

21. The apparatus according to claim 20, wherein the apparatus is comprised in a central unit of an access node.

22. The apparatus according to claim 21, comprising computer program code configured to cause the apparatus to:
indicate whether NULL security mode is allowed,
indicate a non-user equipment specific frequency band filter.

23. The apparatus according to claim 22, comprising computer program code configured to cause the apparatus to:
perform admission control at the apparatus after the radio resource control connection setup has been completed for the user equipment.

24. The apparatus according to claim 23, comprising computer program code configured to cause the apparatus to:
enable a default security algorithm configuration thereby eliminating a dependency on NG Application Protocol signaling during initial access.

25. The apparatus according to any of the claim 24 comprising computer program code configured to cause the apparatus to:
include indication of a common frequency band filter in the setup response message.

26. The apparatus according to any of the claim 25, comprising computer program code configured to cause the apparatus to:
include indication of access stratum security establishment preference.

27. A system comprising:
an apparatus;
at least one processor; and
at least one memory, said at least one memory stored with computer program code thereon, the at least one memory and the computer program code configured to, with the at least one processor, cause the apparatus at least to:
receive an interface setup request from a distributed unit of a wireless communication network;
prepare a first information element for informing non-user equipment specific and common radio bearer configuration for a signalling radio bearer between a central unit and a user equipment;
prepare a second information element for informing non-user equipment specific frequency band information;
prepare a third information element for informing a common non-user equipment specific security mode related information;
include the first information element, the second information element and the third information element in a setup response message; and
send the setup response message to the distributed unit.

28. The system according to claim 27, wherein the apparatus is comprised in a central unit of an access node.

29. The system according to claim 28, comprising computer program code configured to cause the apparatus to:
indicate whether NULL security mode is allowed,
indicate a non-user equipment specific frequency band filter.

30. The system according to claim 29, comprising computer program code configured to cause the apparatus to:
perform admission control at the apparatus after the radio resource control connection setup has been completed for the user equipment.

31. The system according to claim 30, comprising computer program code configured to cause the apparatus to:
enable a default security algorithm configuration thereby eliminating a dependency on NG Application Protocol signaling during initial access.

32. The system according to any of the claim 31 comprising computer program code configured to cause the apparatus to:
include indication of a common frequency band filter in the setup response message.

33. The system according to any of the claim 32, comprising computer program code configured to cause the apparatus to:
include indication of access stratum security establishment preference.
